(19) United States
(12) Patent Application Publication
(10) Pub. No.: US 2020/0126145 A1
(43) Pub. Date: Apr. 23, 2020

(54) SYSTEM AND METHOD FOR MANAGEMENT OF WEB ORDER PLACEMENT

(71) Applicant: Nippon Gas Co., LTD., Tokyo (JP)

(72) Inventor: Shinji Wada, Tokyo (JP)

(21) Appl. No.: 16/338,086

(22) PCT Filed: Aug. 30, 2017
(86) PCT No.: PCT/JP2017/031172

§ 371 Date: Mar. 29, 2019

(30) Foreign Application Priority Data
Sep. 29, 2016 (JP) 2016-191268

(51) Int. Cl. G06Q 30/06; G06Q 20/08; G06Q 10/08; G06Q 50/06

(52) U.S. Cl. CPC G06Q 30/0635; G06Q 50/06; G06Q 10/083; G06Q 20/085

(57) ABSTRACT

A series of processing ranging from the order placement for a gas tool to the payment in relation to a gas appliance are typically carried out with paper-based forms, and an improved efficiency has been desired. At the same time, progress has been made in web-based drafting software, thus allowing drawings to be prepared on a website. In view of such a current situation, there is a demand for a system and a method whereby a series of processing ranging from the order placement for the gas tool to the payment are carried out via a website. The order of a gas tool and the installation work from a gas provider, a completion report from a supplier, an approval to the completion report, and the payment to the supplier are carried out via a website.

### RELATED APPLICATION

This application is a National Stage Application of International Patent Application No. PCT/JP2017/031172, filed Aug. 30, 2017, which claims priority to Japanese Patent Application No. 2016-191268, filed Sep. 29, 2016, both entitled “SYSTEM AND METHOD FOR MANAGEMENT OF WEB ORDER PLACEMENT” and both of which are hereby incorporated by reference in their entirety.

### TECHNICAL FIELD

The present invention relates to a system and a method for the management of web order placement. More specifically, the invention relates to a system and a method by which an order from a gas provider for a gas tool and the installation work, a construction completion report from a supplier, an approval to the construction completion report, and the payment to the supplier are carried out via a website.

### BACKGROUND ART

When a gas provider of town gas and LP gas for example receives a request from a customer to purchase a gas tool, then the gas provider places an order for the gas tool (e.g., a gas cooking appliance, an alarm, or a gas fan heater) and the installation work. The order for the gas tool is sent to a manufacturer while the order for the installation work is sent to a construction company (there may be a case where the manufacturer and the construction company are one company). Upon receiving the order, the manufacturer checks the inventory and the construction company adjusts the schedule of a worker, respectively. If the delivery date must be adjusted, then the manufacturer and the construction company (hereinafter collectively referred to as “supplier”) sends, via FAX or an e-mail, an available delivery date to the gas provider (or sends a scheduled delivery date of the gas tool or a scheduled work date of the installation work) to adjust the delivery date. The supplier may send, after the construction is completed, a construction completion report to the gas provider. A completion report regarding a gas tool installation work may be required to include a construction photograph and/or a drawing to be submitted. The gas provider approves the completion report and the payment to the supplier is performed. Each supplier receives, via FAX or an e-mail for example, a payment note obtained by preparing a list of orders for which the monthly payment is scheduled. If the completion report is incomplete, the completion report is rejected and returned to the supplier. The supplier corrects the rejected inadequate part to send the completion report again.

Currently, construction photographs and/or drawings are delivered to the gas provider in such a manner that a responsible staff of the construction company is allowed to store, in an electronic data storage medium, drawing and/or photograph data prepared using drawing software installed in a computer terminal of the company. The approval result to the completion report is sent from the gas provider to the supplier via FAX or an e-mail for example.

However, a series of processing as described above ranging from the order placement for the gas tool to the payment are typically based on paper sheets, although some construction drawings are prepared by electronic files using drawing software such as a CAD tool. Thus, these processes have been desired to be streamlined. On the other hand, web-based drawing software has been increasingly used. Thus, drawings can be prepared on a website provided by a web server computer in which a web server application is installed via a browser in a client terminal. In view of the situation as described above, such system and method have been required that can perform, via a website, a series of processing as described above ranging from the order placement for the gas tool to the payment. Although gas tools (equipment) in particular are described herein, such a web-based streamlining of a series of processing ranging from the order placement for the gas tool to the payment has been required not only for gas tools but also for tools (equipment) requiring an installation work (e.g., fire-fighting equipment, electric equipment, building equipment).

### SUMMARY OF INVENTION

In order to achieve the objective as described above, the present invention provides a server computer for managing an order of a gas tool and an installation work. The server computer is configured to:

receive order data indicating order contents from a first computer used by an orderer;

prepare schedule data regarding the installation work based at least on the order data;

receive completion report data indicating report contents regarding a completion of the installation work from a second computer used by a supplier having accepted the order of the gas tool or the installation work;

receive approval result data indicating an approval result regarding the report contents from the first computer or a third computer used by an approver; and

prepare, when the approval result indicates an approval, payment data indicating payment contents for the order to the supplier.

According to the server computer described in the above paragraph, the server computer is further configured not to accept the completion report data when the completion report data indicating the report contents regarding the completion of the installation work does not include construction drawing data and/or construction photograph data regarding the installation work.

According to the server computer according to the previous two paragraphs, the server computer is further configured to receive the completion report data that is corrected from the second computer when the approval result indicates a rejection, the approval result data including approval result data indicating an approval result regarding the corrected completion report data.

According to the server computer according to the previous three paragraphs, the server computer is further configured to receive scheduled delivery date data indicating a scheduled delivery date of the gas tool or a scheduled work date of the installation work from the second computer, the scheduled delivery date data being prepared further based on the order data.

According to the server computer according to the previous four paragraphs, the server computer is further configured to send the payment data to the second computer.

In another embodiment, the present invention provides a method of managing the order of a gas tool and the installation work, the method comprising:

receiving order data indicating order contents from a first computer used by an orderer;

preparing schedule data regarding the installation work based at least on the order data;

receiving completion report data indicating the report contents regarding a completion of the installation work from a second computer used by a supplier having accepted the order of the gas tool or the installation work;

receiving approval result data indicating an approval result regarding the report contents from the first computer or a third computer used by an approver; and

preparing, when the approval result indicates an approval, payment data indicating payment contents for the order to the supplier.

In another embodiment, the present invention further provides a computer-readable storage medium having a computer-executable instruction for allowing a computer to execute a method of managing the order of a gas tool and the installation work. The method comprises:

receiving order data indicating order contents from a first computer used by an orderer;

preparing schedule data regarding the installation work based at least on the order data;

receiving completion report data indicating the report contents regarding a completion of the installation work from a second computer used by a supplier having accepted the order of the gas tool or the installation work;

receiving approval result data indicating an approval result regarding the report contents from the first computer or a third computer used by an approver; and

preparing, when the approval result indicates an approval, payment data indicating payment contents for the order to the supplier.

### Advantageous Effects of Invention

As described above, according to the present invention achieves, via a website, an order of a gas tool and the installation work from a gas provider, a completion report from a supplier, an approval to the completion report, and the payment to the supplier. More specifically, a construction company can request a construction work to a gas provider by preparing a drawing on a website via a browser to upload the drawing. The gas provider can manage, via the website, the status of the approval to the completion report, thus allowing the supplier to know the approval in on a real-time basis to cope with a situation especially when the report is rejected. Furthermore, the supplier can know the payment status of each order on a real-time basis without the need to wait for a payment note of each month.

### BRIEF DESCRIPTION OF DRAWINGS

FIG. 1 illustrates a system configuration according to one embodiment of the present invention;

FIG. 2 illustrates, regarding a gas tool and the installation work, a series of processing ranging from the order placement for the gas tool to the payment according to one embodiment of the present invention;

FIG. 3 illustrates data stored in a supplier data storage unit according to one embodiment of the present invention;

FIG. 4 illustrates data stored in an order data storage unit according to one embodiment of the present invention;

FIG. 5 illustrates data stored in a scheduled delivery date data storage unit according to one embodiment of the present invention;

FIG. 6 illustrates data stored in a schedule data storage unit according to one embodiment of the present invention;

FIG. 7 illustrates data stored in a completion report data storage unit according to one embodiment of the present invention;

FIG. 8 illustrates data stored in an approval result data storage unit according to one embodiment of the present invention; and

FIG. 9 illustrates data stored in a payment data storage unit according to one embodiment of the present invention.

### DESCRIPTION OF EMBODIMENTS

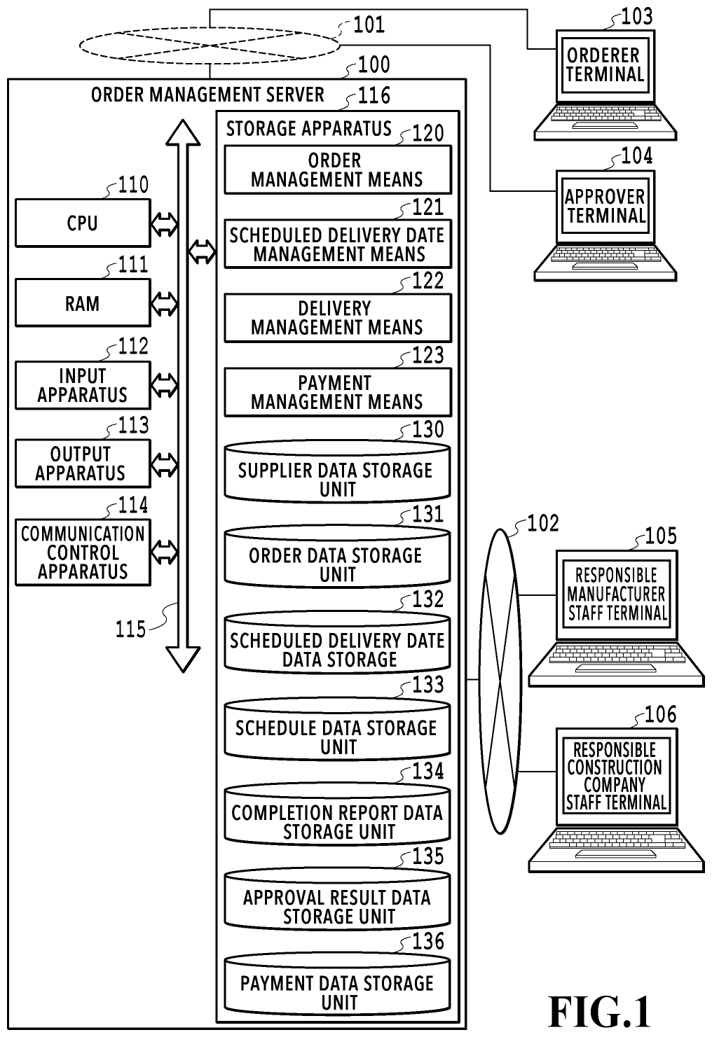

The following section will describe in detail a system and a method according to an embodiment of the present invention with reference to the attached drawings. FIG. 1 illustrates the system configuration according to one embodiment of the present invention. An order management server 100 provided in a data center for example is configured to communicate, via a network 101 (e.g., an intranet), an orderer terminal 103 provided in a gas provider office for example and to communicate, via a network 102 (e.g., the Internet), a responsible manufacturer staff terminal 105 or a responsible construction company staff terminal 106 provided in the company of the manufacturer or the construction company for example. The order management server 100 in FIG. 1 is represented as one server computer. However, the order management server 100 also can be structured as a distributed computing system composed of a plurality of server computers. Depending on a request from each terminal, the order management server 100 provides, to each terminal, a website to perform a process ranging from the order placement to the payment for a gas tool for example. The order management server 100 can request each terminal to go through the login authentication or can limit the function depending on a login user or a terminal accessing the website.

The orderer terminal 103 and the approver terminal 104 are a computer terminal that is provided in the business office of the gas provider for example and that has a browser application installed therein. The orderer terminal 103 is a terminal used by an orderer performing the order of a gas tool and the installation work. The approver terminal 104 is a terminal used by an approver responsible for the approval for a completion report from a supplier. The orderer terminal 103 and the approver terminal 104 may be one terminal when the orderer and the approver are from one source for example. If a plurality of people are responsible for the approval, a plurality of approver terminals 104 may be used. The orderer terminal 103 and the approver terminal 104 may be a mobile terminal carried by each responsible staff. The orderer operates a website provided that is provided by the order management server 100 and that is displayed on a browser in the orderer terminal 103 to process an order to the supplier. The approver operates a website displayed on the approver terminal 104 and confirms the completion report from the supplier to perform an approval processing.

The responsible manufacturer staff terminal 105 and the responsible construction company staff terminal 106 are a computer in which a browser application is installed. The responsible manufacturer staff terminal 105 is a terminal that is installed in a manufacturer company and that is used by a responsible staff of the manufacturer upon receiving an order for a gas tool. The responsible construction company staff terminal 106 is a terminal that is provided in a construction company and that is used by a responsible staff of the construction company upon receiving an order for the installation work of a gas tool. The responsible manufacturer staff terminal 105 and the responsible construction company staff terminal 106 may be one terminal when the order for the gas tool and the order for the installation work are given to one company. These terminals also may be mobile terminals carried by the respective responsible staffs. The manufacturer responsible staff operates a website provided by the order management server 100 displayed on the browser in the responsible manufacturer staff terminal 105 to confirm the details regarding the order for the gas tool to input a scheduled delivery date. Similarly, the responsible construction company staff operates the website displayed on the browser in the responsible construction company staff terminal 106 to confirm the details regarding the order for the installation work of the gas tool to input a scheduled work date to process the construction completion after the gas tool installation work.

Next, the following section will describe in detail the configuration of the order management server 100. In FIG. 1, a single server computing system is assumed and only a required configuration is shown. The order management server 100 includes a CPU 110, a RAM 111, an input apparatus 112, an output apparatus 113, a communication control apparatus 114, and a storage apparatus 116 connected via a system bus 115, respectively. The storage apparatus 116 is configured by a nonvolatile storage medium (e.g., ROM, HDD) and includes a program storage region storing therein an order management processing-related software program and a data storage region storing therein data handled by the software program. The respective means of the program storage region described below are actually an independent software program, the routine thereof and components and are stored in the storage apparatus 116. The respective means are called from the storage apparatus 116 by the CPU 110 for the execution and are executed in a work area of the RAM 111. Thus, various functions can be provided while allowing an access to a database for example.

The software programs stored in the program storage region of the storage apparatus 116 include those related to the present invention only such as an order management means 120, a scheduled delivery date management means 121, a delivery management means 122, and a payment management means 123. These means are executed by the CPU 110. Although not shown, the storage apparatus 116 also stores therein a web server application-related program. The order management server 100 has a web server function.

The order management means 120 receives, from the orderer terminal 103, the order data showing the details of the order (e.g., the installation work of a gas tool) to store the data in an order data storage unit 131. Upon receiving a request from the responsible manufacturer staff terminal 105 for example, the order management means 120 acquires the order data to an applicable manufacturer from the order data storage unit 131 to send the data to the responsible manufacturer staff terminal 105 from which the request has been sent for example.

The scheduled delivery date management means 121 receives a scheduled delivery date to the details of the order (e.g., a desired delivery date) from the responsible manufacturer staff terminal 105 and the responsible construction company staff terminal 106 to store the scheduled delivery date in the scheduled delivery date data storage unit 132. When the delivery as specified in the details of the order is possible, the reception of the scheduled delivery date data may be omitted. Then, based on the received order data and/or scheduled delivery date data, the order management means 120 prepares schedule data to store the schedule data in a schedule data storage unit 133. In response to a request from the orderer terminal 103 for example, the order management means 120 acquires the prepared schedule data from the schedule data storage unit 133 to send the data to the orderer terminal 103 from which the request has been sent for example.

The delivery management means 122 receives, from the responsible construction company staff terminal 106, completion report data showing the report details regarding the completion of the installation work of the gas tool to store the completion report data in a completion report data storage unit 134. The delivery management means 122 receives, from the approver terminal 104, approval result data showing the approval result regarding the completion report to store the approval result data in an approval result data storage unit 135. Furthermore, in response to a request from the responsible construction company staff terminal 106 for example, the delivery management means 122 acquires the approval result data regarding the applicable construction company from the approval result data storage unit 135 to send the approval result data to the responsible construction company staff terminal 106 from which the request has been sent for example. When the received completion report data does not include a required construction drawing attached thereto for example, the delivery management means 122 can automatically reject the received completion report data.

When the approval result regarding the completion report shows an approval, the payment management means 123 prepares payment data to store the data in a payment data storage unit 136. This payment data shows the details of the payment to a supplier (which is a manufacturer in the case of the payment to a gas tool delivery or a construction company in the case of the payment to a gas tool installation work). The payment management means 123 prepares a list of the prepared payment data for each supplier (e.g., a PDF file having an arbitrary payment note format) to send the list to the responsible manufacturer staff terminal 105 or the responsible construction company staff terminal 106. Each responsible staff of the supplier also can download the payment note having an arbitrary format from the website via the responsible manufacturer staff terminal 105 or the responsible construction company staff terminal 106.

Next, the data storage region in the storage apparatus 116 includes those only related to the present invention such as a supplier data storage unit 130, the order data storage unit 131, a scheduled delivery date data storage unit 132, the schedule data storage unit 133, the completion report data storage unit 134, the approval result data storage unit 135, and the payment data storage unit 136, any of which is a fixed storage region secured in the storage apparatus 116.

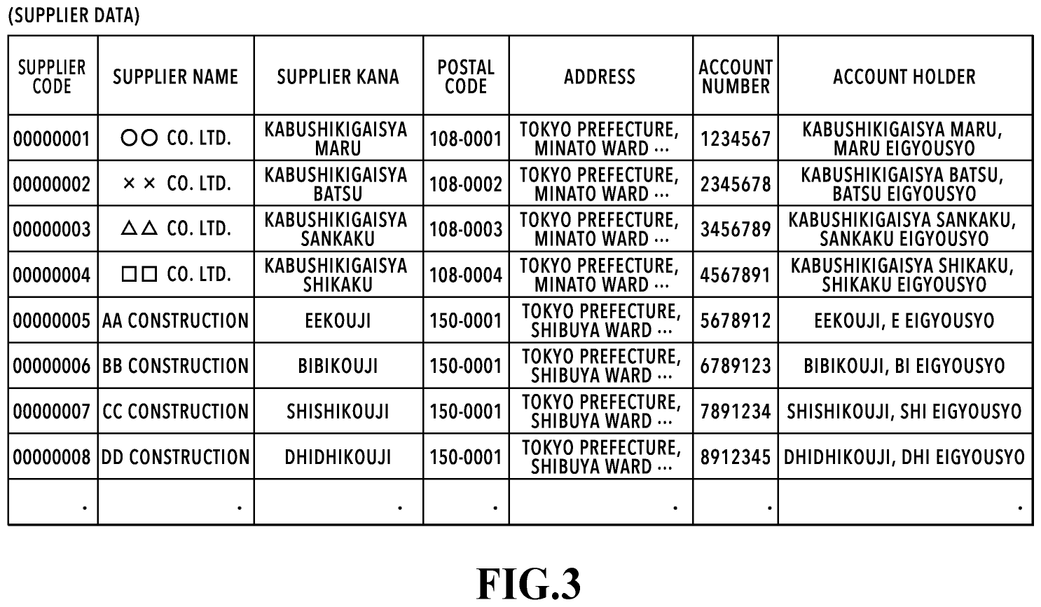

The supplier data storage unit 130 stores data regarding the manufacturer and the construction company to which the gas tool and the installation work have been ordered. FIG. 3 shows data stored in the supplier data storage unit 130 according to one embodiment of the present invention. The supplier data in FIG. 3 includes the “supplier code” uniquely showing the manufacturer and the construction company, the “supplier name” and the “supplier name Kana” showing the name and Yomigana of the manufacturer and the construction company, the “postal code” and “address” showing the postal code and the addresses of the manufacturer and the construction company, as well as the “account number” and “account holder” showing the settlement account information of the manufacturer and the construction company.

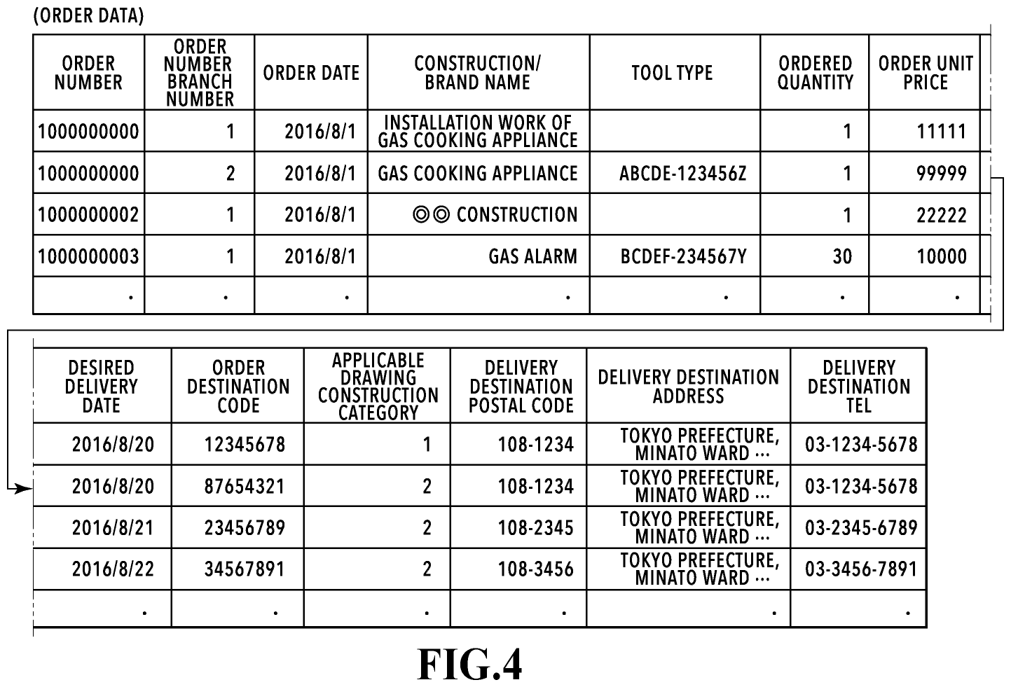

The order data storage unit 131 stores data regarding the details of the order from the gas provider to the supplier. FIG. 4 shows data stored in the order data storage unit 131 according to one embodiment of the present invention. The order data in FIG. 4 includes the “order number” and “order number branch number” uniquely showing this data (the details of which will be described later), the “order date” showing the date at which the order was made, the “construction/brand name” showing the construction details or the brand name of the gas tool, the “tool model” showing the model of the gas tool in the case of the order of the gas tool, the “ordered quantity” and “order unit price” showing the ordered quantity and the unit price of the installation work or the gas tool, the “desired delivery date” showing a desired date on which the gas tool delivery or the installation work is performed, the “order destination code” uniquely showing the order destination, the “applicable drawing construction category” showing whether or not the submission of a construction drawing is required in the case of the installation work, the “delivery destination postal code” and “delivery destination address” showing the delivery destination of the gas tool or the construction site information of the installation work, and the “delivery destination TEL”. This data is unique by combining the “order number” and the “order number branch number”. As shown in the first and second records in FIG. 4, in the case of the installation work of a gas cooking appliance for example, an order to the construction company regarding the installation work of the gas cooking appliance and an order to the manufacturer regarding the gas cooking appliance to be installed can be managed by the same “order number” and a different “order number branch number”. By storing the same code as the “supplier code” in the supplier data (FIG. 3), the “order destination code” can be linked to the “supplier code”. In FIG. 4, the “desired delivery date” is specified to include only a date. However, the “desired delivery date” also can be specified to include a time or time zone for example (when the time zone is specified, data items such as “scheduled start time” and a “scheduled completion time” also can be added). The “applicable drawing construction category” can be set as “1” when the submission of a construction drawing is required in relation to the applicable installation work and can be set to “2” when such a submission is not required for example. This can consequently provide a control to prevent the completion from being reported when no construction drawing is attached to an installation work completion report from the construction company in spite of the attachment is required for example. Such a control also can be provided not only to construction drawings but also to construction photographs. The order data in FIG. 4 is assumed as data regarding an order from a certain gas provider. However, another embodiment can additionally use “order source codes” uniquely showing the gas providers as an order source, thereby providing the management of the order data from a plurality of gas providers.

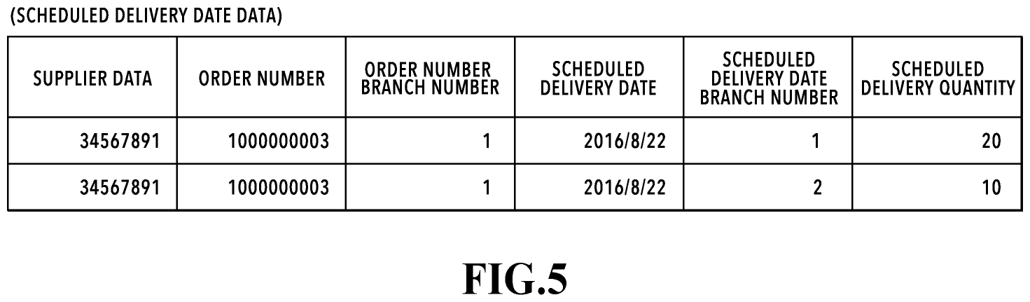

The scheduled delivery date data storage unit 132 stores, regarding the order from the gas provider, data for the scheduled delivery date or the scheduled work date responded from the supplier. FIG. 5 shows data stored in the scheduled delivery date data storage unit 132 according to one embodiment of the present invention. In FIG. 5, the scheduled delivery date data includes the “supplier code” uniquely showing the manufacturer and the construction company to which the order of the gas tool and the installation work was sent, the “order number” and “order number branch number” showing the corresponding details of the order, the “scheduled delivery date” showing a scheduled delivery date, the “scheduled delivery date branch number” (the details of which will be described later) used when a partial delivery is made, and the “scheduled delivery quantity” showing the scheduled delivery quantity. By storing the same code as the “supplier code” in the supplier data (FIG. 3), the “supplier code” can be linked to the “supplier code”. Similarly, the “order number” and “order number branch number” can be linked to the “order number” and “order number branch number” in the order data (FIG. 4). The “scheduled delivery date branch number” is used when a partial delivery is made. For example, the two records in FIG. 5 are the scheduled delivery date data corresponding to the fourth record of the order data of FIG. 4 (order number “1000000003”) and show that, regarding the ordered quantity 30, two deliveries are made by the scheduled delivery quantities 20 and 10. Thus, this data is unique by the four “order number”, “order number branch number”, “scheduled delivery date”, and “scheduled delivery date branch number”. This data is not required when the delivery can be made as specified in the details of the order (e.g., a desired delivery date, an ordered quantity) shown by the order data (FIG. 4).

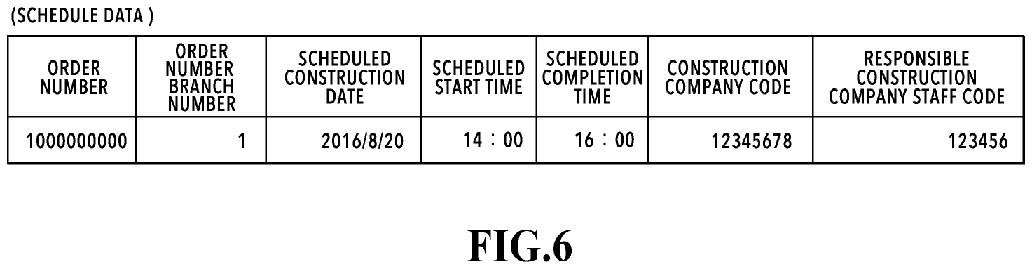

The schedule data storage unit 133 stores data regarding the schedule of the installation work by the construction company. FIG. 6 shows data stored in the schedule data storage unit 133 according to one embodiment of the present invention. In FIG. 6, the schedule data includes the “order number” used to uniquely show the corresponding order data, the “order number branch number”, the “scheduled construction date” showing the scheduled date and time of the gas tool installation work, the “scheduled start time” and “scheduled completion time”, as well as the “construction company code” and “responsible construction company staff code” uniquely showing the construction company performing the installation work and the responsible staff. As described above for the order data in FIG. 4, this data also can be managed by allowing the installation work of the gas tool and the gas tool to have the same order number. The “order number” and the “order number branch number” correspond to the “order number” and “order number branch number” in the order data (FIG. 4). When a plurality of types of gas tools are installed with regard to an order for one installation work, additional data items such as the “order number branch number 1”, “order number branch number 2”, and “order number branch number 3” . . . or other records can be prepared to track the correspondence therebetween. In FIG. 6, the schedule data is shown only for the schedule of the installation work of the gas tool. However, data regarding the holidays of the construction company and/or a responsible construction company staff also can be stored to manage the schedule of the construction company.

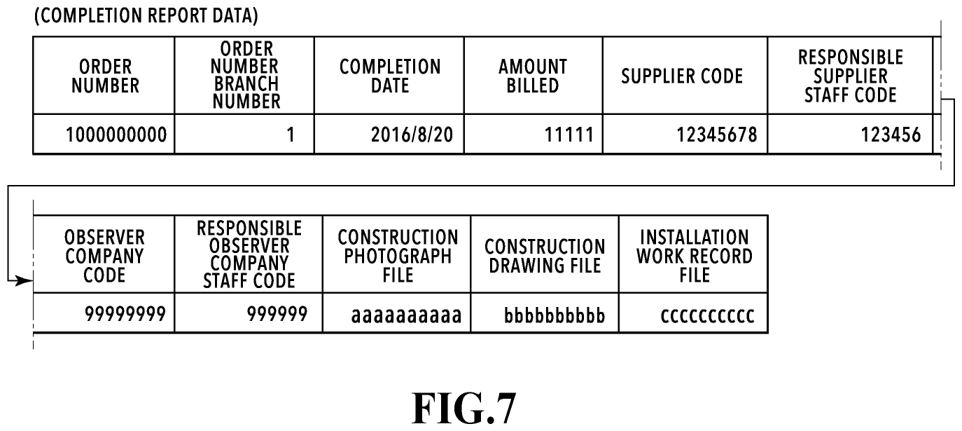

The completion report data storage unit 134 stores therein data regarding the report from the construction company for the completion of the installation work. FIG. 7 shows data stored in the completion report data storage unit 134 according to one embodiment of the present invention. In FIG. 7, the completion report data includes the “order number” and “order number branch number” uniquely showing the corresponding details of the order, the “completion date” showing the work completion date, the “billed amount” showing an amount billed regarding the work, the “supplier code” and “responsible supplier staff code” uniquely showing the supplier preparing the completion report and the responsible staff, as well as the “construction photograph file”, “construction drawing file”, and “equipment construction record file” showing the respective storage destinations of the construction photograph file, the drawing file, and the equipment construction record file (equipment construction report), respectively. The “construction photograph file”, “construction drawing file”, and “equipment construction record file” may be files themselves (e.g., an image data file, a drawing data file, a PDF file) or also may be an address of the storage destination of the data file for example. When the completion report is rejected, the supplier responsible for the rejection performs a corrective action to correct this data, thereby sending a completion report again. A new record also can be prepared in this data whenever a completion report is made. However, in this case, a data item such as “the number of application(s)” for example must be added in order to uniquely show this data.

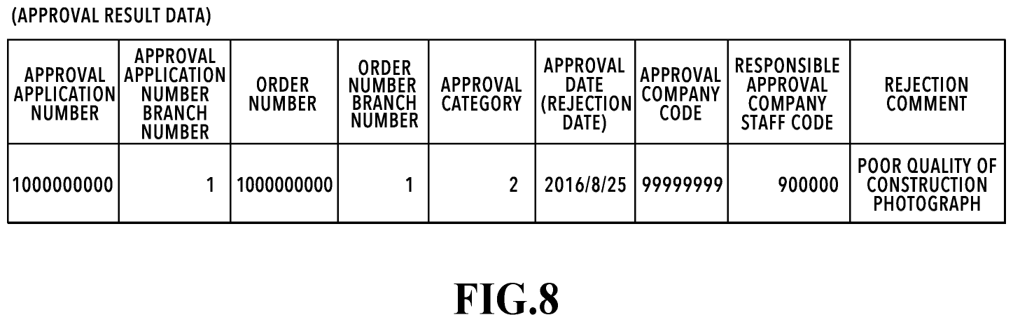

The approval result data storage unit 135 stores therein data regarding the approval result from the gas provider regarding the completion report from the supplier. FIG. 8 shows data stored in the approval result data storage unit 135 according to one embodiment of the present invention. In FIG. 8, the approval result data includes the “approval application number” and “approval application number branch number” (the details of which will be described later) to uniquely show this data, the “order number” and “order number branch number” uniquely showing the details of the order corresponding to the completion report subjected to the approval processing, the “approval category” showing the approval result, the approval date (rejection date) on which the approval or rejection is made, the “approval company code” and “responsible approval company staff code” uniquely showing the gas business company issuing an approval (if applicable) and the responsible staff, as well as the “rejection comment” showing the reason of the rejection (if applicable). Regarding the “approval application number” and “approval application number branch number”, in the case of the approval result regarding the second completion report after one rejection for example, the “approval application number” has the same number as that prior to the rejection but the “approval application number branch number” has the number different from the previous one. By doing this, this data can be managed as history data. The “approval category” can be set to “1” when the approval result is an approval and can be set to “2” when the approval result is rejection. When there are a plurality of approvers, this data can further include data items such as the “primary approval category”, the “secondary approval category”, and the “third approval category” . . . showing the approval categories for the primary approval, the secondary approval, and the third approval, respectively for example so that a plurality of approval results can be retained. In this case, a plurality of “responsible approval company staff codes” also can be retained by preparing the “primary responsible approval company staff code”, “secondary responsible approval company staff code”, and “third responsible approval company staff code” . . . for example. When the approval is made by a plurality of approvers, the approval result can be determined as “approval pending” so long as all approval results show an approval. When the approval result shows rejection, a control can be provided to prevent the payment to the supplier from being executed regarding the applicable order.

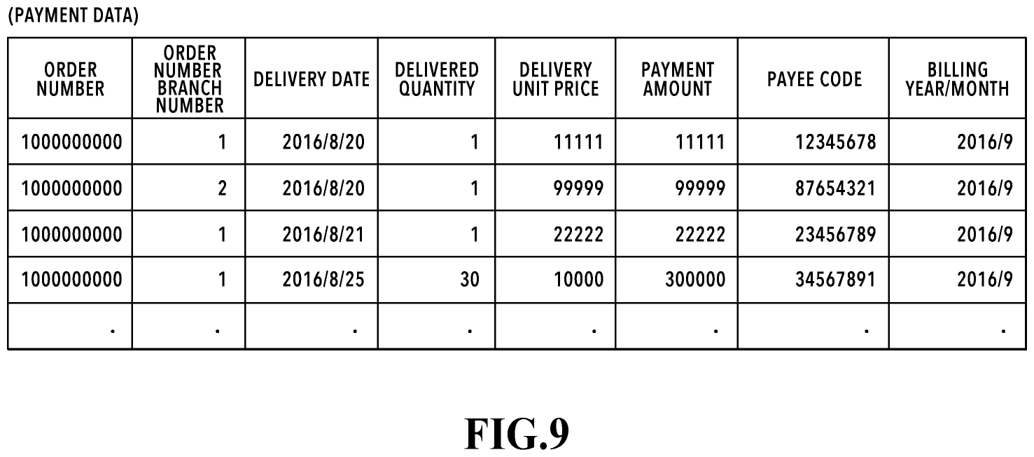

The payment data storage unit 136 stores therein data regarding the payment for the gas tool delivery and the installation work. FIG. 9 shows data stored in the payment data storage unit 136 according to one embodiment of the present invention. In FIG. 9, the payment data includes the “order number” and “order number branch number” to uniquely show the order data of the payment (FIG. 4), the “delivery date” showing the delivery or the work completion date, the “delivered quantity” and “delivery unit price” showing the delivered quantity of the installation work or gas tool(s) and the unit price, the “payment amount” showing the payment amount obtained by calculating the delivered quantity*the delivery unit price, the “payee code” uniquely showing the manufacturer and the construction company as a payee, as well as the billing year/month showing a month I which the payment is fixed. In FIG. 9, the payment data is shown so as to collectively retain data regarding different payees. When this data is sent to the respective companies, only data applicable to the respective will be sent.

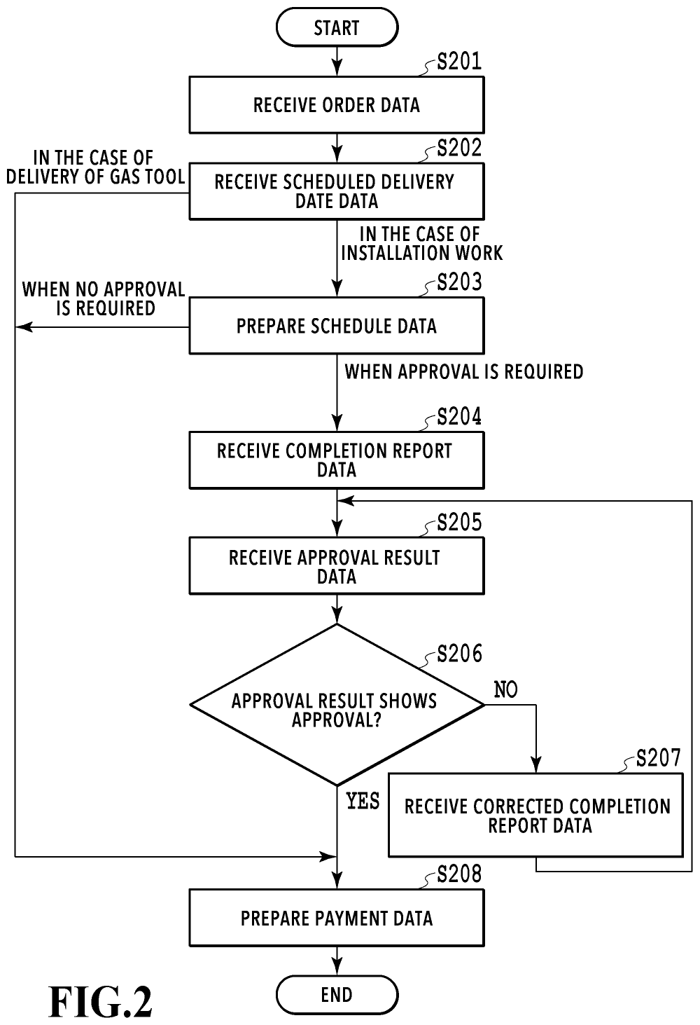

Next, with reference to the flowchart of FIG. 2 and the data of FIGS. 3-9, the following section will describe the flow of the order management processing according to one embodiment of the present invention. This processing performs a series of processing ranging from the order placement for the gas tool to the payment for the gas tool via a website.

FIG. 2 is a flow diagram illustrating a series of processing ranging from the order placement for the gas tool to the payment regarding a gas tool and the installation work according to one embodiment of the present invention. In this embodiment, it is assumed that a website provided by the order management server 100 is accessed by the respective responsible staffs of a gas provider, a manufacturer, and a construction company to perform a series of processing ranging from the order placement for the gas tool to the payment regarding a gas tool and the installation work.

First, in Step 201, the order management means 120 receives, from the orderer terminal 103, the order data (FIG. 4) showing the details of the order of a gas tool and the installation work to store the order data in the order data storage unit 131. This order data is prepared by allowing a responsible staff for the order of the gas provider to use the orderer terminal 103 to input required data through an order placement processing screen for example on the website or by selecting a supplier to which is the order is placed from a list of the manufacturers and construction companies displayed using the supplier data (FIG. 3) for example. The responsible staff of the manufacturer or the construction company uses the responsible manufacturer staff terminal 105 or the responsible construction company staff terminal 106 to refer to the order data displayed on the website to confirm the details of the order to the company for which the staff works. The order management server 100 can use the “order destination code” in the order data (FIG. 4) to control the access so that the responsible staff can confirm only the order data regarding the company for which the staff works.

Next, the order management means 120 receives, from the responsible manufacturer staff terminal 105 or the responsible construction company staff terminal 106, the scheduled delivery date data (FIG. 5) showing the scheduled delivery date of the gas tool or the scheduled work date of the installation work for which the order has been made to store the scheduled delivery date data in the scheduled delivery date data storage unit 132 (Step 202). The scheduled delivery date data is prepared by allowing the responsible staff of the manufacturer or the construction company to use the responsible manufacturer staff terminal 105 or the responsible construction company staff terminal 106 to input required data through an available delivery screen on the website for example. The responsible staff of the manufacturer or the construction company can omit the input (preparation) of the scheduled delivery date data when the delivery or work is possible as specified by the details of the order shown by the order data (FIG. 4) (e.g., a desired delivery date, an ordered quantity). In this case, the order management server 100 can assume that the delivery based on the details of the order data is possible to proceed to the next step if no response is received within a predetermined period after the order for example (or when the scheduled delivery date data is not received). In the case of an order requesting the delivery of a gas tool not requiring an installation work and thus no approval is required from the gas provider as an order source in particular, the processing does not proceed to the next step. In this case, the processing can proceed to the preparation of payment data in Step 208 after the “scheduled delivery date” in the scheduled delivery date data (FIG. 5) for example.

Next, the order management means 120 prepares the schedule data (FIG. 6) schedule data (FIG. 6) based on the received order data and/or scheduled delivery date data for example to store the schedule data in the schedule data storage unit 133 (Step 203). The prepared schedule data can be referred to through the orderer terminal 103 for example via a website.

Next, the delivery management means 122 receives, from the responsible manufacturer staff terminal 105 or the responsible construction company staff terminal 106, the completion report data (FIG. 7) showing the report details regarding the completion of the installation work of the gas tool to store the completion report data in the completion report data storage unit 134 (Step 204). This completion report data is prepared by allowing the responsible staff of the construction company to use, after the installation work is completed, the responsible construction company staff terminal 106 to input required data through the completion report screen on the website for example. The responsible staff of the construction company also can use the responsible construction company staff terminal 106 to upload construction photographs (image files) through the website and to use web drawing software provided in the website to prepare and upload construction drawings (a drawing data file). The construction photographs and the construction drawing file is assumed as completion report data (FIG. 7) that requires an approval from the gas provider as an order source. Thus, the delivery management means 122 can provide a control to prevent the completion from being reported when all of required construction photographs and construction drawing file are not available. In another embodiment, when the submission of a construction drawing is required (or when the order data (FIG. 4) has the “applicable drawing construction category” set to “1” (applicable)) and the completion report data does not include a construction drawing file for example, the report can be automatically rejected (e.g., the “approval category” is set to “2”) and approval result data (FIG. 8) including the “rejection comment” set to a fixed form comment of “no construction drawing” for example is prepared) to return the report to the construction company (in this case, the processing proceeds to the “No” route of Step 206 (which will be described later)). The construction photograph also can be subjected to this automatic rejection.

Next, the delivery management means 122 receives, from the approver terminal 104, approval result data (FIG. 8) showing the approval result from the gas provider regarding the completion report from the supplier to store the approval result data in the approval result data storage unit 135 (Step 205). When the approval result shows rejection (or when the approval result data has the “approval category” of “2”), then the processing proceeds to the “No” route of Step 206. Then, a responsible staff of the supplier having received the rejection performs a corrective action to correct the completion report data (FIG. 7). The corrected completion report data is sent from the responsible manufacturer staff terminal 105 or the responsible construction company staff terminal 106 to the order management server 100 and is received by the delivery management means 122 and is stored in the completion report data storage unit 134 (Step 207). After Step 207, Steps 205-207 are repeated until the approval is obtained from the gas provider (or until the approval result data has the “approval category” of “1”). When there are a plurality of approvers, Steps 205-207 are repeated until the approval is obtained from all of the approvers.

When the approval result shows an approval (or when the approval result data has the “approval category” of “1”), then the processing proceeds to the Yes route of Step 206. Then, the payment management means 123 prepares the payment data (FIG. 9) showing the details of the payment to the supplier to store the payment data in the payment data storage unit 136 (Step 208). The payment management means 123 can send the payment data for each supplier to the responsible manufacturer staff terminal 105 and/or the responsible construction company staff terminal 106 at a predetermined timing and with an arbitrary format (e.g., a PDF file having a payment note format). In another embodiment, instead of sending the payment data to the supplier, the payment data can be confirmed and downloaded via a website through the responsible manufacturer staff terminal 105 or the responsible construction company staff terminal 106. After Step 208, this processing is completed.

After this (or on a predetermined execution date), based on the payment data (FIG. 9), the payment processing is executed to the settlement account of each supplier set in the supplier data (FIG. 3).

As described above, the order of a gas tool and the installation work from the gas provider, the completion report from the supplier, an approval to the completion report, and the payment to the supplier can be achieved via a website.

1. A server computer for managing an order of a gas tool and an installation work, the server computer is configured to:
receive order data indicating order contents from a first computer used by an orderer;
prepare schedule data regarding the installation work based at least on the order data;
receive completion report data indicating report contents regarding a completion of the installation work from a second computer used by a supplier having accepted the order of the gas tool or the installation work;
determine whether construction drawing data and construction photograph data regarding the installation work are required;
determine whether the completion report data includes the construction drawing data and/or the construction photograph data required, when it is determined that the completion report data includes the construction drawing data and/or the construction photograph data required;
send first approval result data indicating a rejection to the second computer when the completion report data does not include the construction drawing data and/or the construction photograph data required;
receive second approval result data indicating an approval result regarding the report contents from the first computer or a third computer used by an approver; and
prepare, when the approval result indicates an approval, payment data indicating payment contents for the order to the supplier.

2. (canceled)

3. The server computer according to claim 1, further being configured to receive the completion report data that is corrected from the second computer, the second approval result data including approval result data indicating an approval result regarding the corrected completion report data.

4. The server computer according to claim 1, further being configured to receive scheduled delivery date data indicating a scheduled delivery date of the gas tool or a scheduled work date of the installation work from the second computer, the scheduled delivery date data being prepared based on the order data.

5. The server computer according to claim 1, further being configured to send the payment data to the second computer.

6. A method implemented by a computer for managing the order of a gas tool and an installation work, comprising:
receiving, by the computer, order data indicating order contents from a first computer used by an orderer;
preparing, by the computer, schedule data regarding the installation work based at least on the order data;
receiving, by the computer, completion report data indicating the report contents regarding a completion of the installation work from a second computer used by a supplier having accepted the order of the gas tool or the installation work;
determine, by the computer, whether construction drawing data and construction photograph data regarding the installation work are required;
determine, by the computer, whether the completion report data includes the construction drawing data and/or the construction photograph data required, when it is determined that the completion report data includes the construction drawing data and/or the construction photograph data required;
send, by the computer, first approval result data indicating a rejection to the second computer when the completion report data does not include the construction drawing data and/or the construction photograph data required;
receiving, by the computer, second approval result data indicating an approval result regarding the report contents from the first computer or a third computer used by an approver; and
preparing, by the computer, when the approval result indicates an approval, payment data indicating payment contents for the order to the supplier.

7. A computer-readable storage medium having a computer-executable instruction for allowing a computer to execute a method of managing an order of a gas tool and an installation work, the method includes:
receiving order data indicating order contents from a first computer used by an orderer;
preparing schedule data regarding the installation work based at least on the order data;
receiving completion report data indicating the report contents regarding a completion of the installation work from a second computer used by a supplier having accepted the order of the gas tool or the installation work;
determining whether construction drawing data and construction photograph data regarding the installation work are required;
determining whether the completion report data includes the construction drawing data and/or the construction photograph data required, when it is determined that the completion report data includes the construction drawing data and/or the construction photograph data required;
sending first approval result data indicating a rejection to the second computer when the completion report data does not include the construction drawing data and/or the construction photograph data required;
receiving second approval result data indicating an approval result regarding the report contents from the first computer or a third computer used by an approver; and
preparing, when the approval result indicates an approval, payment data indicating payment contents for the order to the supplier.

8. The server computer according to claim 3, further being configured to receive scheduled delivery date data indicating a scheduled delivery date of the gas tool or a scheduled work date of the installation work from the second computer, the scheduled delivery date data being prepared based on the order data.

9. The server computer according to claim 3, further being configured to send the payment data to the second computer.

10. The server computer according to claim 4, further being configured to send the payment data to the second computer.

11. The server computer according to claim 8, further being configured to send the payment data to the second computer.
